(19) United States
(12) Patent Application Publication
(10) Pub. No.: US 2015/0146977 A1
(43) Pub. Date: May 28, 2015

(54) COMPRESSION DEVICE AND COMPRESSION METHOD

(71) Applicant: SAMSUNG DISPLAY CO., LTD., Yongin-City (KR)

(72) Inventor: Isamu RYU, Yokohama (JP)

(21) Appl. No.: 14/552,909

(22) Filed: Nov. 25, 2014

(30) Foreign Application Priority Data
Nov. 28, 2013 (JP) 2013-246681

(51) Int. Cl. G09G 3/32; G06T 9/00; G06N 5/04

(52) U.S. Cl. CPC G09G 3/3208; G06N 5/04; G06T 9/00; G09G 2320/043; G09G 2350/00
USPC 382/166

(57) ABSTRACT

A compression device includes a memory, a compressor, and an adder. The memory has a first area, a second area, and a third area. The first area stores a first totalizing value of a first pixel of a pixel group. The second area stores first selection information corresponding to a first model, selected to calculate a first prediction value corresponding to second totalizing values of peripheral pixels of the pixel group. The third area stores first differences between the second totalizing values and the first predication value. The compressor obtains the second totalizing values based on information stored in the first, second, and third areas. The adder obtains a third totalizing value by adding a first current luminance value of the first pixel to the first totalizing value, and obtains fourth totalizing values by adding second current luminance values of the peripheral pixels to the second totalizing values.

### CROSS-REFERENCE TO RELATED APPLICATION

Japanese Application No. 2013-246681, filed on Nov. 28, 2013, and entitled, “Compression Device and Compression Method,” is incorporated by reference herein in its entirety.

### BACKGROUND

1. Field

One or more embodiments described herein relate to a compression device and a compression method.

2. Description of the Related Art

An organic electroluminescence (EL) display is thin and consumes low power, and therefore is suitable for use in many electronic devices. Over time, the pixels of this type of display deteriorate in terms of their performance.

### SUMMARY

In accordance with one embodiment, a compression device includes a memory including a first area to store a first totalizing value of a first pixel of a pixel group, a second area to store first selection information corresponding to a first model selected to calculate a first prediction value corresponding to second totalizing values of peripheral pixels of the pixel group other than the first pixel, and a third area to store first differences between the second totalizing values and the first predication value; compressor to obtain the second totalizing values based on information stored in the first, second, and third areas; and an adder to obtain a third totalizing value by adding a first current luminance value of the first pixel to the first totalizing value, and to obtain fourth totalizing values by adding second current luminance values of the peripheral pixels to the second totalizing values.

The device may include a model selector to select one of a plurality of predetermined models including the first model, and to output second selection information; a model predictor to calculate a second prediction value using the selected model and based on the second selection information; and a difference calculator to calculate second differences between the fourth totalizing values and the second prediction value.

The memory may store the third totalizing value in the first area, the second selection information in the second area, and the second differences in the third area. The device may include a quantizer to quantize the third totalizing value and the second difference, where the third totalizing value and the quantized second difference may be stored in the memory.

The mode selector may select one of the models depending on a distribution of differences between the third totalizing value and the fourth totalizing values. The plurality of models may be one of the first model and a second model, the first model uses the first totalizing value as an initial value and predicts the second totalizing values based on the initial value and one straight line, and the second model divides the peripheral pixels into a first sub pixel group and a second sub pixel group, predicts first sub totalizing values of pixels in the first sub pixel group based on the initial value and one straight line, and predicts second sub totalizing values of pixels in the second sub pixel group based on a maximum or a minimum value of the first sub totalizing value.

The model selector may select the first model when a difference between the third totalizing value and the fourth totalizing values has a first distribution, and the second model when a difference between the third totalizing value and the fourth totalizing values has a second distribution, wherein a degree of dispersion of the second distribution is greater than that of the first distribution.

In accordance with another embodiment, a method operates a compression device which includes a memory having a first area to store a first totalizing value of a first pixel of a pixel group, a second area to store first selection information corresponding to a model selected to calculate a first prediction value for second totalizing values of peripheral pixels of the pixel group other than the first pixel, and a third area to store first differences between the second totalizing values and the first predication value. This method includes: obtaining the second totalizing values based on information stored in the first through, second, and third areas; obtaining a third totalizing value by adding a first current luminance value of the first pixel to the first totalizing value; obtaining fourth totalizing values by adding second current luminance values of the peripheral pixels to the second totalizing values; and storing the third totalizing value and the fourth totalizing values.

In accordance with another embodiment, a compression device includes a predictor to calculate prediction values of peripheral pixels based on totalizing information of a first pixel; a calculator to calculate totalizing values of the peripheral pixels based on the prediction values, and to add a luminance value to a totalizing value of the first pixel and the totalizing values of the peripheral pixels to generate updated totalizing values; a selector to select a model from a plurality of models; a subtractor to determine differences between information of the model and the updated totalizing values; quantizing the updated totalizing values; and controlling storage of the quantized updated totalizing values and the differences determined by the subtractor in a memory, the quantized updated totalizing values corresponding to compressed pixel values.

The selector may select the first model or the second model based on the updated totalizing values. The model selector may select between a first model and a second model, the first model having first information and the second model having second information different from the first information. The first information may include a line of a first slope, and the second information may include a line of a second slope different from the first slope. The subtractor may determine the differences as differences between the line of the selected one of the first or second models and the updated totalizing values. The memory may be within the compression device.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display device;

FIG. 2 illustrates an embodiment of a pixel circuit;

FIG. 3 illustrates an embodiment of a compression device;

FIG. 4 illustrates an embodiment of a data structure;

FIG. 5 illustrates an embodiment of a compression model;

FIG. 6 illustrates another embodiment of a compression model;

FIGS. 7 A and 7B illustrate an embodiment for operating a device; and

FIG. 8 illustrates an embodiment of a compression method.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

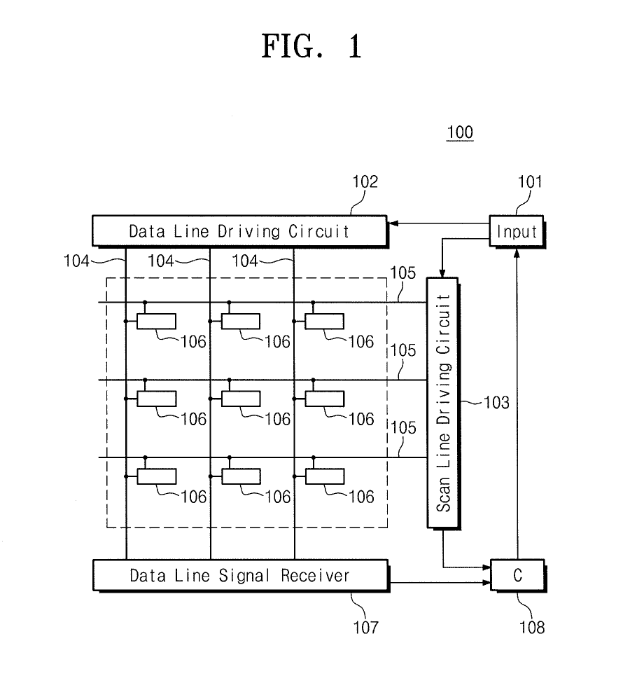

FIG. 1 illustrates an embodiment of a display device 100 which includes an image input circuit 101, a data line driving circuit 102, a scan line driving circuit 103, a data line signal receiving circuit 107, and a compression circuit (C) 108.

The image input circuit 101 is a circuit that receives image information of an image to be displayed on a display surface of the display device 100. The image information may include, for example, information relating to television broadcasting image, information of an image read from a medium (e.g., DVD (Digital Versatile Disc)), and/or information of an image obtained through a communication network such as the Internet. The image information may include, for example, information indicating a moving picture or a still image.

The data line driving circuit 102 is connected to a plurality of data lines 104.

The data line driving circuit 102 outputs luminance information to the plurality of data lines 104. The luminance information corresponds to pixel circuits 106 connected to respective ones of the scan lines selected by the scan line driving circuit 103.

The scan line driving circuit 103 is connected to a plurality of scan lines 105.

The scan lines 105 may be sequentially selected by the scan line driving circuit 103, or may be selected by another method.

A pixel circuit 106 at the intersection of a data line 104 and a scan line 105 is connected to the data line 104 and the scan line 105. When the data line 104 is selected by the scan line driving circuit 103, the pixel circuit 106 connected to the scan line 105 reads luminance information, which the data line driving circuit 102 outputs, from the data line 104. The luminance information may be indicative of the luminance of an image to be displayed at the pixel circuit 106.

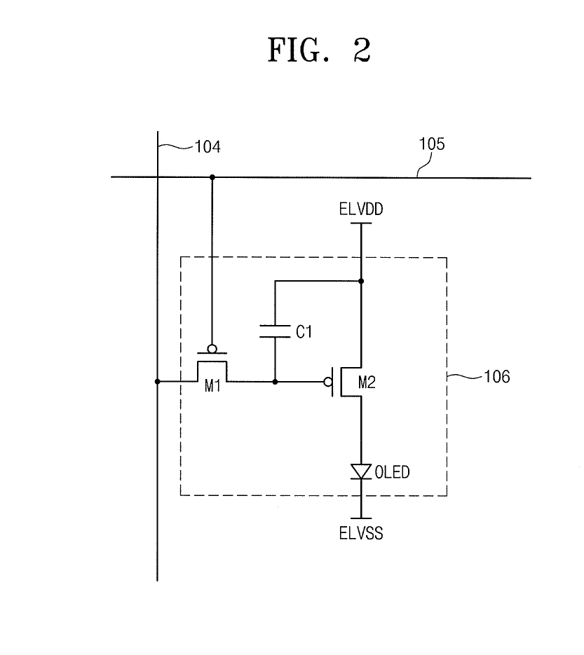

FIG. 2 illustrates an embodiment of a pixel circuit, which, for example, may correspond to the pixel circuit 106 in FIG. 1. Referring to FIG. 2, the pixel circuit may include an organic EL element (OLED) or other type of light emitter. A corresponding one of the scan lines 105 is connected to a gate electrode of a switch M1. When the scan line 105 is not selected, the switch M1 may be turned off. When the scan line 105 is selected, the switch M1 may be turned on. When the switch M1 is turned on, luminance information from a data line driving circuit 102 is supplied to a first end of a capacitor C1 through the data line 104. The capacitor C1 stores the luminance information.

The first end of the capacitor C1 is connected to a gate electrode of a switch M2. The amount of current that flows from ELVDD to ELVSS through the switch M2 is adjusted depending on the luminance information stored in the capacitor C1. Until a next scan line is selected, an amount of current corresponding to the luminance information flows into the organic EL element OLED. During this time, light emission corresponding to the stored luminance information is maintained.

Returning to FIG. 1, a data line signal receiving circuit 107 receives luminance information to be supplied to each data line 104. The luminance information is output to a compression device 108 whenever each scan line is selected. The compression device 108 reads a luminance value, indicating luminance information output from the data line signal receiving circuit 107, by the scan line. Also, the compression device 108 determines information about a selected scan line 105 from the scan line driving circuit 103 and totalizes the luminance value of each pixel.

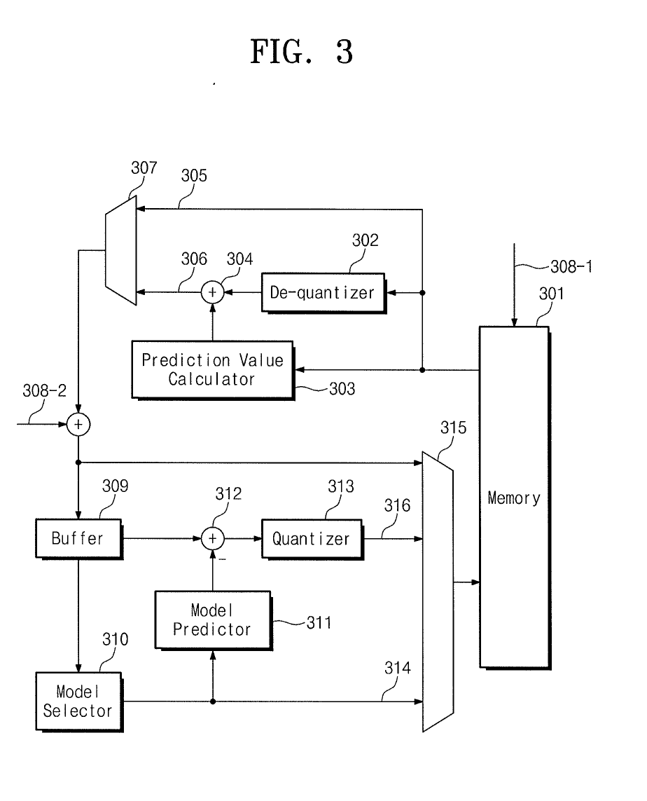

FIG. 3 illustrates an embodiment of a compression device, which, for example, may correspond to the compression device 108 in FIG. 1. The compression device includes a memory 301 for storing a totalizing result (e.g., a totalizing value of luminance values) of luminance information of each pixel. In another embodiment, the memory 301 may be coupled to and thus not included in the compression device 108.

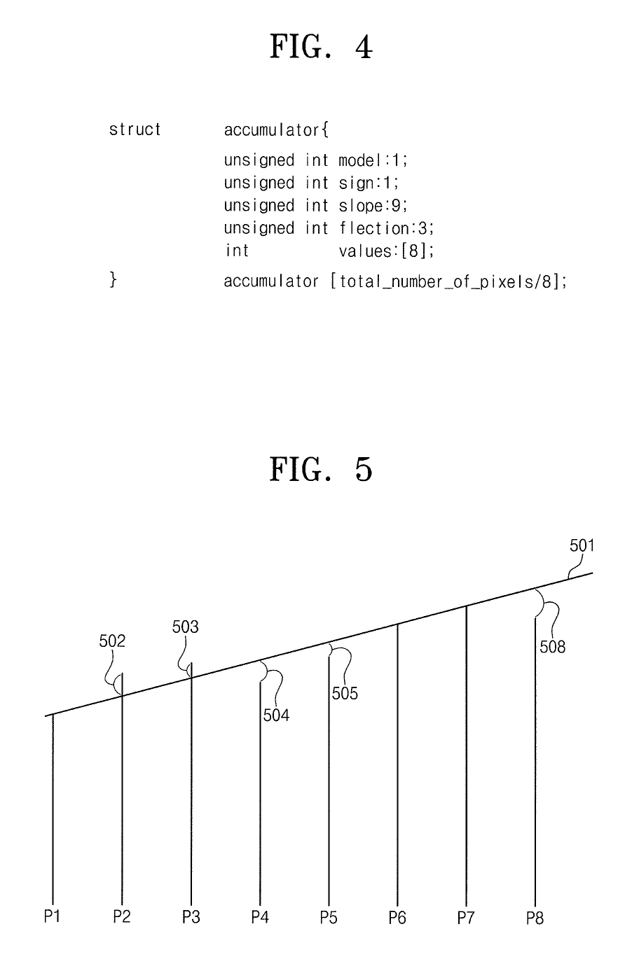

FIG. 4 illustrates an example of a data structure which the memory 301 may use to store a totalizing value of each pixel. Referring to FIG. 4, a data structure defined as an accumulator, for example, is used to store accumulation of luminance information of pixel circuits on a predetermined number (e.g., 8) data lines. Therefore, the number of accumulation elements may have a value obtained by dividing the total number of pixels total_number_of pixels by the predetermined number (e.g., 8).

The data structure defined as the accumulator has members (or parameters) named ‘model’, ‘sign’, ‘slope’, ‘flection’, and ‘values’. The model denotes a model selected for compression. In one embodiment, two possible models may be selected for compression. When two models are possible for selection, one bit may be assigned to the model, e.g., in FIG. 4 the selected mode is denoted by ‘1.’

FIG. 5 illustrates an example of a model that may be selected for compression.

In FIG. 5, reference symbols P1, P2, P3, P4, P5, P6, and P7 denote eight pixels connected to a selected scan line 105. The reference symbols P1, P2, P3, P4, P5, P6, and P7 may, for example, denote eight pixels that are consecutively disposed in a row direction. A compression device 108 may define eight pixels as one group. In another embodiment, a different number of pixels may define one group.

In FIG. 5, the lengths of lines that are drawn on the reference symbols P1, P2, P3, P4, P5, P6, P7, and P8 and that extend in a vertical direction may indicate a totalizing value of a luminance value, including luminance information to be supplied to each pixel, which is referred to as a totalizing value. The Y axis indicates a totalizing value, and P1, P2, P3, P4, P5, P6, P7, and P8 are disposed on the X axis perpendicular to the Y axis with the same interval.

In FIG. 5, totalizing values of luminance of the remaining P2 through P8, other than P1, may be calculated depending on a totalizing value of luminance of P1 and a straight line 501. The straight line 501 intersects P1 and has a predetermined slope. For example, if P1 is a totalizing value of P1 and v is a slope of the straight line 501, a totalizing value of Pn may be calculated based on the following equation: v*(n−1)+P1, where n is a natural number indicating an order of a pixel of the group except P1. Furthermore, P1 may be referred to as a first pixel of the group, and P2 through P8 may be referred to as peripheral pixels.

If totalizing values of P2 through P8 do not exist on the straight line 501, a difference between a totalizing value of each of P2 through P8 and the straight line 501 is stored in ‘values’. For example, a first difference 502 between a totalizing value P2 and the straight line 501 is stored in ‘value[1]’ (e.g., a subscript of the accumulator complies with C language and starts from ‘0’). A second difference 504 between a totalizing value P3 and the straight line 501 is stored in ‘value[2]’, a third difference 504 between a totalizing value P4 and the straight line 501 in ‘value[3]’, a fourth difference 505 between a totalizing value P5 and the straight line 501 in ‘value[4]’, and a seventh difference 508 between a totalizing value P8 and the straight line 501 in ‘value[7]’. Now that totalizing values of P6 and P7 are on the straight line 501, a fifth difference between a totalizing value P6 and the straight line 501 and a sixth difference between a totalizing value P7 and the straight line 501 are ‘0’. ‘0’ is stored in ‘values[5]’ and ‘values[6]’.

Also, a difference between a totalizing value of Pn may be calculated based on the following equation: Pn−(v*(n−1)+P1), where Pn is the totalizing value and v denotes a slope of the straight line 501. For example, v may be calculated by the least squares method. For example, calculation may be performed so that a sum of the square of 2 about the first difference, the square of 2 about the second difference, the square of 2 about the third difference, the square of 2 about the fourth difference, the square of 2 about the fifth difference, the square of 2 of the sixth difference, and the square of 2 about the seventh difference is minimized.

Also, a totalizing value of ‘P0’ is stored in ‘value[0]’.

Also, members ‘sign’ and ‘slope’ may indicate a slope v of the straight line 501.

For example, the member ‘sign’ denotes whether a slope value of the straight line 501 is positive, and the member ‘slope’ denotes an absolute value of the slope value of the straight line 501. Therefore, for example, one bit may be assigned to indicate whether a slope of the straight line 501 is positive or negative, and nine bits may be assigned to the absolute value of the slope value of the straight line 501.

Accordingly, when a model corresponding to FIG. 5 is used, a totalizing value of each pixel Pn may be calculated based on the equation: (−1)sign*slope*(n−1)+value[0]+value[n−1]. For example, the member ‘sign’ is 0 when the slope value of the straight line 501 is positive and 1 when the slope value of the straight line 501 is negative.

A portion of a memory at which ‘values[0]’ for storing a totalizing value of a first pixel of the group is stored may be referred to as a first area. A second area may correspond to a memory portion at which the members ‘model’, ‘sign’, and ‘slope’ are stored, as information about a model for calculating prediction values of totalizing values of the remaining pixels of the group other than the first pixel. A third area may correspond to a portion of the memory at which ‘values[1]’ through ‘values[7]’ for storing differences between totalizing values of the remaining pixels of the group other than the first pixel and values predicted through the model are stored.

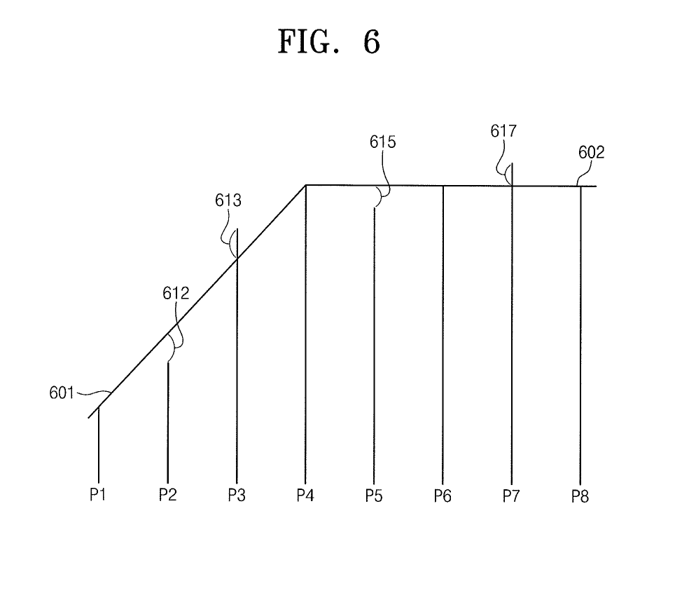

FIG. 6 illustrates another example of a model that may be selected for compression. In FIG. 6, like in FIG. 5, P1, P2, P3, P4, P5, P6, and P7 denote eight pixels connected to a selected scan line 105. For example, P1, P2, P3, P4, P5, P6, and P7 denote eight pixels consecutively disposed in a row direction. A compression device 108 defines eight pixels as one group. The number and arrangement of pixels may be different in another embodiment.

Also, in the present embodiment, P2, P3, and P4 may correspond to a first sub pixel group, and P5, P6, P7, and P8 may correspond to second sub pixel group. In this case, totalizing values of the first and second sub pixel groups may be processed by different models.

For P1 through P4, the difference between the totalizing value of each pixel and a straight line 601 is calculated like the model in FIG. 5. For P5 through P8, the difference between the totalizing value of each pixel and a straight line 602 parallel with the X axis is calculated.

If w is a slope value of the straight line 601, a value calculated by the equation, w*(n−1)+P1−Pn, is stored in ‘value[n−1]’ as the totalizing value of any one Pn of P2 through P4. Also, a totalizing value of P1 is stored in ‘value[0]’.

A value calculated by the equation, w*3+P1−Pm, is stored in ‘value[n−1]’ as the totalizing value of any one Pm of P5 through P8. Also, ‘sign’ and ‘slope’ denote a slope value of the straight line 601.

In this case, because 4 is stored in ‘flection’, the difference between the totalizing value from P2 to P4 and the straight line 601 is stored at each element corresponding to ‘values’. Also, the difference between the totalizing value from P5 to P8 and the straight line 602 is stored at each element corresponding to ‘values’.

Here, ‘flection’ may have, but is not limited to, any natural number more than 2 and less than 7. If r is a value stored in ‘flection’, totalizing values of P1 through Pr are calculated based on a difference with a straight line, of which the slope value is not ‘0’. Totalizing values of Pr+1 through P8 are calculated based on a difference with a straight line, of which the slope value is ‘0’. Thus, in one embodiment, ‘flection’ is a value for classifying the group into a first sub group including P1 through Pr and a second sub group including Pr+1 through P8.

When a model corresponding to FIG. 6 is used, a totalizing value of each pixel from P1 to Pr may be calculated by the equation: (−1)sign*slope*(n−1)+value[0]+value[n−1]. The totalizing value of each pixel from Pr+1 to P8 may be calculated by the equation: (−1)sign*slope*(r−1)+value[0]+value[m−1]. In this case, the equation, (−1)sign*slope*(r−1), may be a maximum value or a minimum value of a totalizing value of a pixel belonging to a first group.

The decision of whether to use the model of FIG. 5 or the model of FIG. 6 may depend on, for example, a distribution of values calculated by the following: (P2−P1), (P3−P1)/2, (P4−P1)/3, (P5−P1)/4, (P6−P1)/5, (P7−P1)/6, and (P8−P1)/7. Values of (P2−P1), (P3−P1)/2, (P4−P1)/3, (P5−P1)/4, (P6−P1)/5, (P7−P1)/6, and (P8−P1)/7 may be interpreted as an average slope.

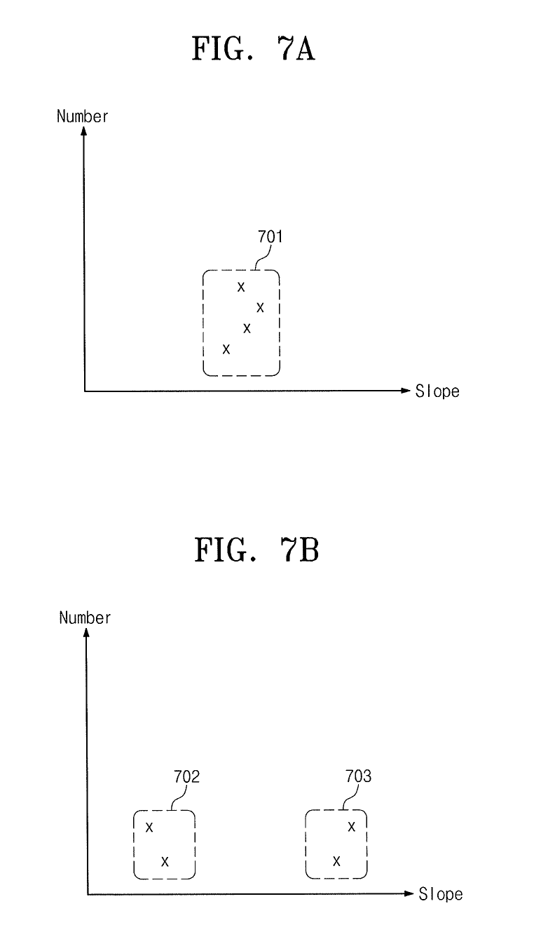

For example, when the model of FIG. 5 is used, values of (P2−P1), (P3−P1)/2, (P4−P1)/3, (P5−P1)/4, (P6−P1)/5, (P7−P1)/6, and (P8−P1)/7 may be distributed at one place 701 in FIG. 7A, because the difference between a totalizing value of each pixel and a straight line 501 is calculated. The model of FIG. 5 may be used when a distribution is focused at one place in a slope and a distribution of pixels having the slope as denoted in FIG. 7A.

When the model of FIG. 6 is used, values of (P2−P1), (P3−P1)/2, (P4−P1)/3, (P5−P1)/4, (P6−P1)/5, (P7−P1)/6, and (P8−P1)/7 may be distributed at a plurality of places 702 and 703 in FIG. 7B, because a difference between a totalizing value of luminance of each pixel and one of straight lines 601 and 602 is calculated. For example, the degree of dispersion in FIG. 6 is greater than in FIG. 5. Thus, the model corresponding to FIG. 6 may be used when a distribution is not focused at one place like a distribution of values in FIG. 7B.

A first area may correspond to a portion of a memory at which ‘values[0]’ for storing a totalizing value of a first pixel of the group are stored. A second area may correspond to a memory portion at which ‘model’, ‘sign’, and ‘slope’ are stored, as information about a model for calculating prediction values of totalizing values of the remaining pixels of the group other than the first pixel. A third area may correspond to a memory portion at which ‘values[1]’ through ‘values[7]’ for storing differences between totalizing values of the remaining pixels of the group other than the first pixel and values predicted through the model are stored.

Also, in the accumulator of FIG. 4, values stored in the remaining members other than members ‘model’ and ‘sign’ to which one bit is assigned may be quantized in a predetermined manner. For example, a share by a predetermined value may be stored. More particularly, quantization about the value of each element of ‘values’ may reduce the number of bits of data stored in ‘values’.

Returning to FIG. 3, a value of a to-be-accumulated element, corresponding to a totalizing value of a pixel connected to a selected scan line 105, may be read when information about the selected scan line 105 is received from a scan line driving circuit 103 as a line 308-1.

A prediction value calculator 303 calculates prediction values of P2 through P8, based on values of ‘model’, ‘sign’, ‘slope’, and ‘flection’ of the read accumulation element. Also, ‘values[1]’ through ‘values[7]’ of ‘values’ other than ‘values[0]’ may be de-quantized through a de-quantizer 302.

The prediction values of P2 through P8 and values of ‘values[1]’ through ‘values[7]’ are sequentially added by a calculator (e.g., an adder) 304, to calculate totalizing values of P2 through P8. An output of the adder 304 is provided to a multiplexer 307. Because it is stored in ‘values[0]’, a totalizing value of PO is output to the multiplexer 307 through a signal line 305 without modification.

An output value of the multiplexer 307 and an output 308-1 of a data line signal receiving circuit 107 (refer to FIG. 1) are sequentially added, and ‘values[0]’ of resultant values is output to a multiplexer 315.

Buffer 309 may store ‘values[0]’ through ‘values[7]’ obtained by sequentially adding an output value of the multiplexer 307 and the output 308-1 of the data line signal receiving circuit 307. Buffer 309 may temporarily store ‘values[0]’ through ‘values[7]’.

A model selector 310 selects a model from a value stored in the buffer 309, and provides a model predictor 311 and a multiplexer 315 with information (a value of ‘model’ and values of ‘sign’ and ‘slope’ (including possibly but not necessarily ‘flection’) indicating the selected model.

The model predictor 311 calculates a value predicted by a model of P2 through P7 and outputs the calculated value to an adder 312. The adder 312 calculates a difference between totalizing values of P2 through P7 stored in a buffer and a value predicted by a model and outputs the calculated value to a quantizer 313 and possibly but not necessarily to a multiplexer 315. The multiplexer 315 receives values of ‘model’, ‘sign’, ‘slope’, ‘flection’, and ‘values’ to write them at the memory 301.

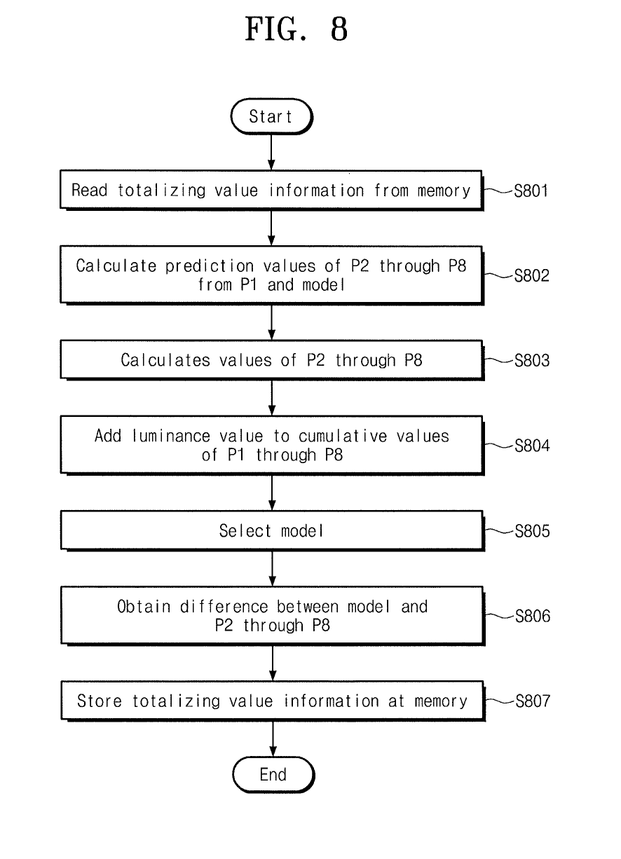

FIG. 8 illustrates an embodiment of a compression method, which includes, in operation S801, reading ‘model’, ‘sign’, ‘slope’, ‘flection’, and ‘values’ from a memory as totalizing value information. In operation S802, a prediction value calculator 303 calculates prediction values of P2 through P8, depending on P1 (values[0]) and ‘sign’ and ‘slope’ (including possibly but not necessarily ‘flection’).

In operation S803, an adder 304 calculates totalizing values of P2 through P8 by adding the prediction values and a value obtained from an element of ‘values’. In operation S804, a luminance value is added to the totalizing values of P1 through P8. This may be performed based on a pixel data value from a data line signal receiving circuit 107. In operation S805, a model is selected based on a result of operation S804.

In operation S806, differences between a value predicted by the model and P2 through P8 are calculated. In operation S807, results of operations S805 and S806 are stored in the memory as totalizing value information.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments described herein.

By way of summation and review, the pixels of an organic EL display deteriorate over time. In an attempt to solve this problem, a technique has been proposed which accumulates a cumulative (totalizing) value of the light-emitting strength every pixel. However, this technique has drawbacks. For example, as screen size increases, the storage capacity for totalizing pixel values (e.g., values indicative of luminance information of pixels) increases. For example, 48 bits may be assigned to each pixel to totalize a full-HD pixel value over ten or more years of the life of the display. Thus, a storage capacity of significant size (e.g., about 95 Mb) must be used to perform totalizing for all pixels in the screen.

In accordance with one or more of the aforementioned embodiments, a device and method are provided which compresses and stores totalizing values in a way that reduces the storage capacity of a memory for accumulating totalizing values. For example, it is possible to reduce the number of bits for storing a totalizing value of a pixel. In one example application, a storage capacity of about 32 Mb may be used to totalize a full-HD pixel value over ten or more years of the product life.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A compression device, comprising:
a memory including a first area to store a first totalizing value of a first pixel of a pixel group, a second area to store first selection information corresponding to a first model selected to calculate a first prediction value corresponding to second totalizing values of peripheral pixels of the pixel group other than the first pixel, and a third area to store first differences between the second totalizing values and the first predication value;
a compressor to obtain the second totalizing values based on information stored in the first, second, and third areas; and
an adder to obtain a third totalizing value by adding a first current luminance value of the first pixel to the first totalizing value, and to obtain fourth totalizing values by adding second current luminance values of the peripheral pixels to the second totalizing values.

2. The device as claimed in claim 1, further comprising:
a model selector to select one of a plurality of predetermined models including the first model, and to output second selection information;
a model predictor to calculate a second prediction value using the selected model and based on the second selection information; and
a difference calculator to calculate second differences between the fourth totalizing values and the second prediction value.

3. The device as claimed in claim 2, wherein the memory is to store the third totalizing value in the first area, the second selection information in the second area, and the second differences in the third area.

4. The device as claimed in claim 3, further comprising:
a quantizer to quantize the third totalizing value and the second difference, the third totalizing value and the quantized second difference to be stored in the memory.

5. The device as claimed in claim 2, wherein the model selector is to select one of the models depending on a distribution of differences between the third totalizing value and the fourth totalizing values.

6. The device as claimed in claim 2, wherein:
the plurality of models is one of the first model and a second model,
the first model uses the first totalizing value as an initial value and predicts the second totalizing values based on the initial value and one straight line, and
the second model divides the peripheral pixels into a first sub pixel group and a second sub pixel group, predicts first sub totalizing values of pixels in the first sub pixel group based on the initial value and one straight line, and predicts second sub totalizing values of pixels in the second sub pixel group based on a maximum value or a minimum value of the first sub totalizing value.

7. The device as claimed in claim 6, wherein the model selector is to select:
the first model when a difference between the third totalizing value and the fourth totalizing values has a first distribution, and
the second model when a difference between the third totalizing value and the fourth totalizing values has a second distribution, wherein a degree of dispersion of the second distribution is greater than that of the first distribution.

8. An method for operating a compression device, which includes a memory having a first area to store a first totalizing value of a first pixel of a pixel group, a second area to store first selection information corresponding to a model selected to calculate a first prediction value for second totalizing values of peripheral pixels of the pixel group other than the first pixel, and a third area to store first differences between the second totalizing values and the first predication value, the method comprising:
obtaining the second totalizing values based on information stored in the first through, second, and third areas;
obtaining a third totalizing value by adding a first current luminance value of the first pixel to the first totalizing value;
obtaining fourth totalizing values by adding second current luminance values of the peripheral pixels to the second totalizing values; and
storing the third totalizing value and the fourth totalizing values.

9. A compression device, comprising:
a predictor to calculate prediction values of peripheral pixels based on totalizing information of a first pixel;
a calculator to calculate totalizing values of the peripheral pixels based on the prediction values, and to add a luminance value to a totalizing value of the first pixel and the totalizing values of the peripheral pixels to generate updated totalizing values;
a model selector to select a model from a plurality of models;
a subtractor to determine differences between information of the model and the updated totalizing values;
quantizing the updated totalizing values; and
controlling storage of the quantized updated totalizing values and the differences determined by the subtractor in a memory, the quantized updated totalizing values corresponding to compressed pixel values.

10. The device as claimed in claim 9, wherein the model selector is to select a first model or a second model based on the updated totalizing values.

11. The device as claimed in claim 9, wherein the model selector is to select between a first model and a second model, the first model having first information and the second model having second information different from the first information.

12. The device as claimed in claim 11, wherein:
the first information includes a line of a first slope, and
the second information include a line of a second slope different from the first slope.

13. The device as claimed in claim 12, wherein the subtractor is to determine the differences as differences between the line of the selected one of the first or second models and the updated totalizing values.

14. The device as claimed in claim 9, wherein the memory is within the compression device.
